(19) United States
(12) Patent Application Publication
(10) Pub. No.: US 2015/0334793 A1
(43) Pub. Date: Nov. 19, 2015

(54) MASTER-SLAVE SYSTEM ON THE SECONDARY SIDE OF A GALVANIC ISOLATION BARRIER (SELV BARRIER) OF AN OPERATING UNIT

(71) Applicant: TRIDONIC GMBH & CO KG, Dornbirn (AT)

(72) Inventor: Simon MAIER, Dornbirn (AT)

(73) Assignee: TRIDONIC GMBH & CO KG, Dornbirn (AT)

(21) Appl. No.: 14/653,476

(22) PCT Filed: Dec. 20, 2013
(86) PCT No.: PCT/AT2013/000211

§ 371 Date: Jun. 18, 2015

(30) Foreign Application Priority Data
Dec. 21, 2012 (DE) 102012224146.9

(51) Int. Cl. H05B 33/08; H05B 37/02

(52) U.S. Cl. CPC H05B 33/0809; H05B 33/0857; H05B 37/0272; H05B 37/0263; H05B 37/0218; H05B 37/0227

(57) ABSTRACT

The invention relates to an operating unit in which dimming information can be fed to a secondary side in respect of a galvanic isolator (4), wherein the operating unit (1) is improved in terms of cost. In particular, the dimming information is fed only to a first module (2) (a master module) either from outside by means of a sensor or from a primary side via the galvanic isolator (4) by means of a wireless channel (52). The first module (2) is further designed to relay the dimming information to at least one second module (3) (at least one slave module). The relaying of the dimming information can be effected either by a local bus (6), a wireless connection (9), a supply line, or via lines on a lamp module (12).

### FIELD OF THE INVENTION

The present invention relates to an operating unit for lamps and to a method for operating lamps which in each case use a master-slave system on the secondary side of a galvanic isolation or isolation barrier (“SELV barrier”, SELV standing for “Separated Extra Low Voltage”) for dimming the lamps. The master-slave system consists especially of a first module and at least one second module.

### BACKGROUND

Operating units with SELV barriers are known from the prior art (e.g. an SELV converter) which have on the secondary side of the SELV barrier a plurality of converter stages arranged in parallel, for example one or more buck converters which initiate the dimming of a lamp allocated in each case, especially an LED line. In these known operating units, dimming information for dimming the lamps, for example the dimming stage to be set, is transmitted from the primary side via the SELV barrier to each of the plurality of converter stages on the secondary side. This is implemented, for example, via a DALI communication link. Optocouplers or transformers for conveying the dimming information via the SELV barrier are also known.

FIG. 1 shows an example of an operating unit 100 from the prior art. The operating unit 100 has on the primary side (with regard to an SELV barrier 104) a power factor correction circuit 105, an ASIC 107 and an interface 106 for transmitting dimming information 103 via the SELV barrier 104. The dimming information 103 is here conveyed in parallel to interfaces of a plurality of converter stages 102. The converter stages 102 in each case control an associated lamp 110 with the aid of an ASIC 108, on the basis of the received dimming information 103. As explained above, the interface 106 is implemented by means of DALI interfaces, optocouplers or transformers.

However, the communication of dimming information or signals shown in FIG. 1, crossing the SELV barrier, is negative with regard to the production costs of the operating units. In particular, optocouplers or transformers set high demands on components for bridging the SELV barrier which leads to high costs in the production of the operating units.

The present invention has the object of improving the known prior art. In particular, it is the object of the present invention to provide dimming information from the primary side to the secondary side of a galvanic isolation in an operating unit for lamps, wherein costly components such as optocouplers should be avoided.

### SUMMARY

The object of the invention is achieved by the features of the independent claims. The core concept of the invention is advantageously developed by the dependent claims.

In particular, the present invention relates to an operating unit for at least one lamp, especially a converter for at least one LED line, which comprises a circuit on the primary side and a circuit on the secondary side which are isolated from one another via a galvanic isolation, wherein the lamps can be supplied on the secondary side with respect to the galvanic isolation and the primary side is configured for connection to a voltage supply, particularly a mains voltage, the circuit on the secondary side comprising a first module and at least one second module for dimming a lamp allocated in each case, the circuit on the primary side and the first module having interfaces for configuring a unidirectional or bidirectional wireless channel, the first module being configured to receive dimming information via the wireless channel and to forward the received dimming information to the at least one second module.

Since the dimming information is transmitted via the wireless channel over the galvanic isolation (i.e. the SELV barrier), no costly optocouplers, transformers etc. are necessary. The first module is preferably a master module and the one or the plurality of second modules is preferably a slave module. All modules are preferably converter stages. The at least one second module can be implemented to be simpler than a conventional converter stage since this second module does not need to receive the dimming information from the primary side of the SELV barrier. Overall, fewer components are therefore necessary for conveying the dimming information via the SELV barrier to the secondary side. The operating unit of the present invention can, therefore, be produced more cost effectively.

Between the first module and the at least one second module, a local bus can be arranged for the first module to communicate with the at least one second module.

The local bus can be constructed on a circuit board of the operating unit. Via the local bus, the dimming information can be forwarded from the first module to the at least one second module. A local bus can be installed simply and cost effectively in the operating unit.

The first module is preferably configured to apply the dimming information to the bus.

By applying the dimming information to the bus, the dimming information can be conveyed rapidly to a multiplicity of second modules. The second modules can detect the dimming information by means of more simple circuits than if it had to be received from the primary side of the SELV barrier.

Between the first module and the at least one second module, a wireless link for the first module to communicate with the at least one second module can also be set up.

The wireless link between the first module and the at least one second module allows the dimming information to be conveyed simply and cost-effectively. To set up the wireless link, the modules can be provided with antennas. Antennas for wireless communication, particularly antennas for radio communication, are small and cheap and, therefore, assist in reducing the costs and the dimensions of the operating unit. The antennas are preferably formed in circuit boards of the circuits of the modules.

The bus or the wireless link, respectively, can be designed for unidirectional communication from the first module to the at least one second module.

Since in this case, the at least one second module does not have to send any information but only has to receive the dimming information via the bus or the wireless link, the at least one second module can be implemented more simply than converter stages from the prior art. In particular, it can be produced to be smaller and more cost effective.

The bus or the wireless link, respectively, can also be designed for bidirectional communication between the first module and the at least one second module.

Due to the bidirectional communication, the at least one second module can feed information back to the first module.

The first module and the at least one second module are preferably configured to exchange the dimming information and/or at least one operating parameter.

The at least one second module can transmit, for example, operating parameters to the first module. The operating parameters can then be sent back, for example via the wireless channel, to the primary side of the operating unit and can be used there as a regulating value for regulating the dimming information. That is to say, the dimming information can be adapted on the basis of the operating parameters and conveyed again. For example, a current through a lamp, a voltage across a lamp, a temperature, a light intensity, a resistance value etc. can be fed back as operating parameters. By this means, a more accurate setting of a dimming stage of the lamps can be achieved by the dimming information conveyed.

The first module and the at least one second module can also be configured to communicate by a power line.

Power line communication preferably takes place via switching information on a supply voltage of the first module and of the at least one second module.

The supply voltage is preferably a direct voltage. The switching information can be, for example, an alternating voltage superimposed on the supply voltage. For example, an AC/power line concept can be used. The power line communication via lines of the supply voltage of the modules is a cost effective alternative since the modules do not have to be connected either by a wireless link or a bus. A supply line is provided already in any case and, therefore, saves additional costs.

The first module and the at least one second module are preferably converter stages.

In particular, the converter stages are buck converters, the first module acting as master converter and the at least one second module acting as slave converter.

The wireless channel is preferably a radio channel which is set up by radio interfaces.

A radio channel can be implemented in a simple manner by radio interfaces such as, for example, antennas which can be installed a small and inexpensive manner.

The radio channel is preferably located within a preferably metallic housing of the operating unit.

Since the radio channel is arranged inside the preferably metallic housing, purely internal communication of the operating unit takes place via the radio channel. Since the housing is preferably made of metal, no interference to the outside can be caused. The internal communication is reliable and, due to the short ranges to be bridged, only needs low radio power (preferably a range of radio power from 1 to 100 mW, more preferably a range from 1 to 10 mW is provided).

The present invention also relates to an operating unit for at least one lamp, especially a converter for at least one LED line, which comprises a circuit on the primary side and a circuit on the secondary side which are isolated from one another by galvanic isolation, wherein the lamps can be supplied on the secondary side with respect to the galvanic isolation and the primary side is configured for connection to a voltage supply, particularly a mains voltage, the circuit on the secondary side comprising a first module and at least one second module for dimming a lamp allocated in each case, the first module comprising at least one sensor and being configured to determine dimming information on the basis of detected sensor information and to forward the dimming information determined to the at least one second module.

This operating unit represents an even more efficient solution with respect to costs. A sensor is cheap to produce and can be installed in a simple manner. In addition, there is no need for communication via the SELV barrier. By this means, further components can be saved and thus costs reduced.

The at least one sensor is preferably a daylight sensor, presence sensor or infrared sensor.

The first module can determine the dimming information on the basis of detected daylight and, for example, set a higher dimming level in the case of less detected daylight and a lower dimming level in the case of more detected daylight. A presence sensor can be used for the first module to be able to increase the dimming level abruptly if a presence of, for example, a person or a vehicle is detected. Finally, the first module with an infrared sensor can be driven via a remote control.

The first module and the at least one second module are preferably integrated in a lamp module, preferably an LED module, which comprises the lamps, preferably LED lines.

Due to the fact that the modules are integrated in the lamp module, they can be formed, for example, in the board, circuit board or PCB of the lamp module. This saves space and is cost effective.

The first module and the at least one second module are preferably configured to communicate via at least one thermal management or resistance readout line of the lamp module.

A plurality of modules can be wired to one another serially or in parallel. All second modules can be dimmed to the same dimming value, namely the dimming value of the first module. The second modules can in each case also be adjusted to a dimming value deviating from the dimming value of the first module but predetermined according to stored tables or predetermined scaling factors. The expenditure in wiring and installation is minimal in this context. The operating unit can be produced in a simple and cost effective manner by this means.

The present invention also relates to an LED lamp having an LED line which is supplied from the secondary side of an operating unit as described before.

The present invention also relates to a method for operating lamps, particularly an LED line, the method comprising: provision of an electrical supply for the lamps by means of a circuit on the primary side and a circuit on the secondary side which are isolated from one another by galvanic isolation, and adjustment of a dimming level of the lamps in accordance with dimming information, the circuit on the secondary side comprising a first module and at least one second module for dimming a lamp allocated in each case, and the circuit on the primary side receiving dimming information via a unidirectional or bidirectional wireless channel and forwarding it to the at least one second module.

The present invention also relates to a method for operating lamps, particularly an LED line, the method comprising: providing an electrical supply for the lamps by means of a circuit on the primary side and a circuit on the secondary side which are isolated from one another by galvanic isolation, and adjustment of a dimming level of the lamps in accordance with dimming information, the circuit on the secondary side comprising a first module and at least one second module for dimming a lamp allocated in each case, and the first module comprising at least one sensor and determining dimming information on the basis of detected sensor information and forwarding the dimming information determined to the at least one second module.

The LED lamp and the two methods for operating lamps achieve the same advantages which are described above for the operating unit.

### BRIEF DESCRIPTION OF THE DRAWINGS

The present invention will now be described more accurately by means of the appended figures.

FIG. 1 shows an operating unit according to the prior art.

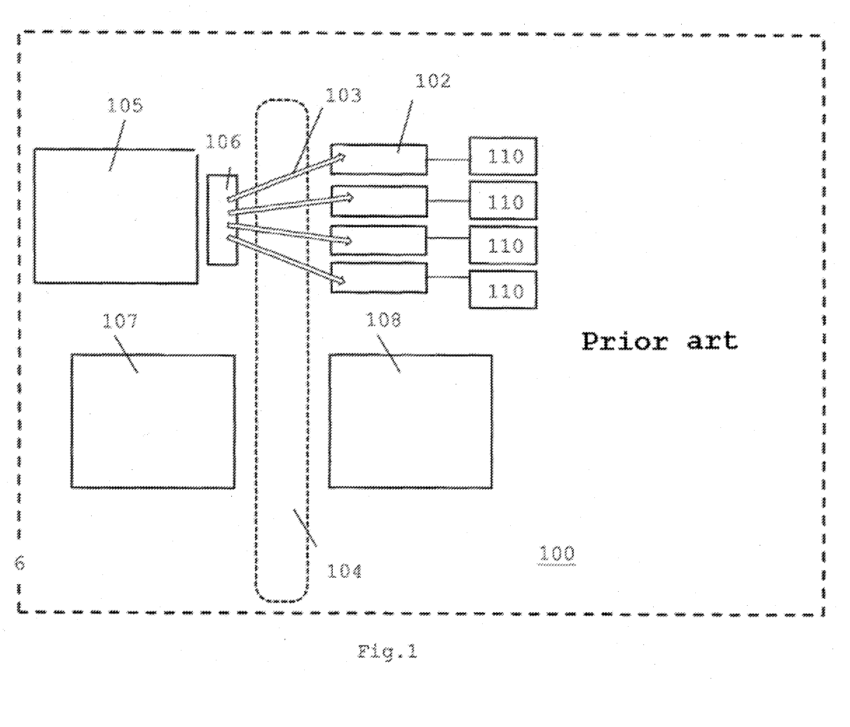

FIG. 2 shows an operating unit according to an exemplary embodiment of the present invention.

FIG. 3 shows an operating unit according to an exemplary embodiment of the present invention.

FIG. 4 shows an operating unit according to an exemplary embodiment of the present invention.

### DETAILED DESCRIPTION OF THE PREFERRED EMBODIMENTS

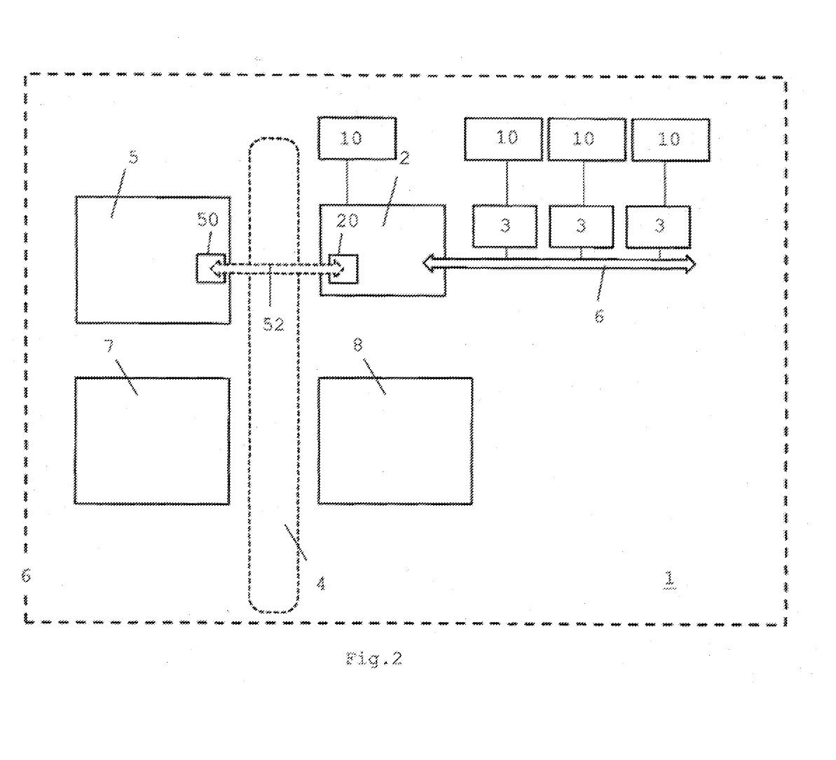

FIG. 2 shows an operating unit 1 according to the invention for at least one lamp 10. The operating unit 1 can be, in particular, an LED converter which operates at least one LED line as lamp 10. In this context, each LED line can have one or more LEDs which send out light of different or identical wavelength. The LEDs of an LED line can be combined, for example, from LEDs emitting red, green and blue in order to generate a white-emitting LED line.

The operating unit 1 has a primary side and a secondary side which are isolated by galvanic isolation 4. On the primary side, at least one circuit on the primary side is preferably provided. In this context, at least one power factor correction circuit (PFC) 5 is located on the primary side, in particular, which is attached to a voltage supply, particularly a mains voltage, and supplies the secondary side of the operating unit 1.

On the primary side, at least one intelligent circuit is preferably provided such as, e.g., an ASIC, a microcontroller or an integrated circuit.

On the secondary side, there is preferably also located at least one such intelligent circuit 8. Furthermore, a plurality of modules 2 and 3, respectively, are arranged on the secondary side. Preferably, a circuit 2, 3 on the secondary side comprises at least one first module 2 and at least one second module 3. In FIG. 2, three second modules 3 are shown as example. All modules 2, 3 can be converter stages which are in each case allocated to one lamp 10 which they can dim.

In the first exemplary embodiment which is shown in FIG. 2, the circuit 5 on the primary side, which comprises at least one PFC, has an interface 50. The first module 2 has an interface 20. The interfaces are used for configuring a unidirectional or bidirectional wireless channel 52 over the galvanic isolation 4. Interfaces 20, 50 can be identical or different antennas which produce a radio link over the galvanic isolation 4. Circuit 5 on the primary side can communicate with the first module 2 on the secondary side via the wireless channel 52. In particular, the first module 2 is configured to receive dimming information via the wireless channel 52. In the first exemplary embodiment, the dimming information is only supplied to the first module 2, that is to say to only one of the converter stages arranged on the secondary side. Since the dimming information is transmitted via the galvanic isolation 4 preferably by means of antennas and via radio, supplying the dimming information does not require any optocoupler or transformer on the secondary side. Thus, a more cost effective solution can be achieved. In addition, a parallel transmission to the modules 2, 3 on the secondary side is avoided. This makes it possible to save components. Furthermore, the second modules 3 can be constructed to be simpler since they do not need an interface corresponding to interface 20.

The first module 2 is connected to the at least one second module 3 via a local bus 6 in the exemplary embodiment of FIG. 2. The local bus 6 is arranged between the plurality of modules 2, 3 on the secondary side in such a manner that the plurality of modules on the secondary side can communicate with one another. The local bus 6 can be constructed to be either unidirectional or bidirectional. If the local bus 6 is constructed to be bidirectional, the plurality of modules 2, 3 on the secondary side can exchange dimming information with one another but also exchange operating parameters, for example for sending them back via the wireless channel 52. If the local bus 6 is constructed to be unidirectional, information can be transmitted preferably only from the first module 2 to the second module 3. For example, the first module 2 can transmit the dimming information to the second module 3 via the bus 6, a signal corresponding to the dimming information being applied preferably to bus 6. The plurality of second modules 3 only need to receive in this exemplary embodiment, or acquire the load on bus 6, but not to send any information. The second modules 3 can thus be implemented in a simpler and more cost effective manner.

Accordingly, the first module 2 is a master module 2 which receives the dimming information from the primary side as the only module on the secondary side. The second modules 3 are slave modules which receive the needed dimming information from the master module. The modules, which are preferably converter stages, thus represent a master-slave system.

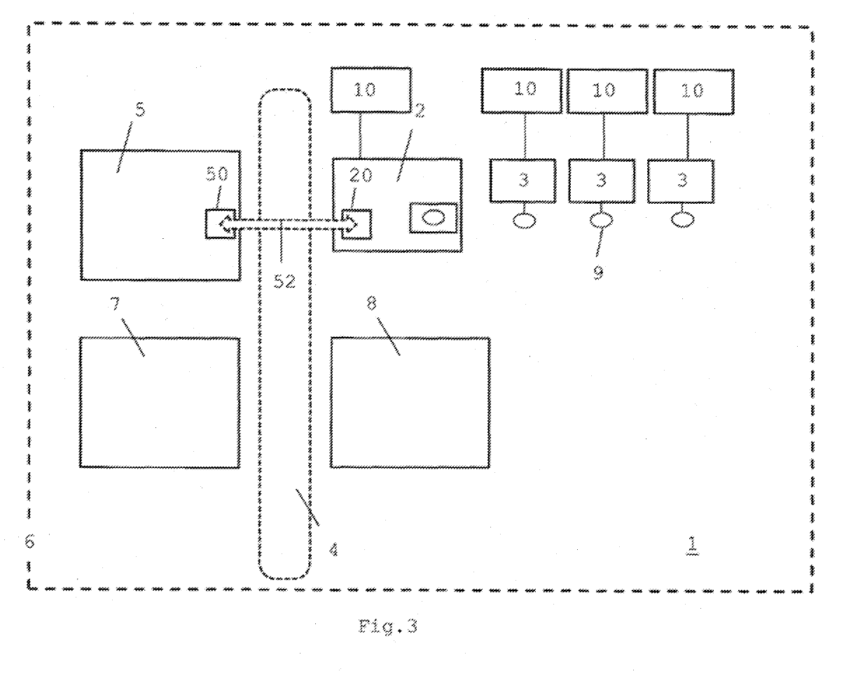

FIG. 3 shows a second embodiment of the present invention. In this arrangement, the local bus 6 on the secondary side, which connects the first module 2 to the at least one second module 3, is replaced by a wireless link 9 for communication among the plurality of modules 2, 3 on the secondary side. As shown in FIG. 3, the wireless link 9 can be configured by a plurality of antennas, each module 2, 3 having one antenna. Accordingly, the wireless link 9 can be a radio link. The modules 2, 3 can also have a wireless interfaces formed in different ways and can communicate, for example, via WLAN, Bluetooth or a similar wireless network. It is also possible to configure the communication via the wireless link 9 bidirectionally or only directionally from the first module 2 to the second module 3.

Antenna 20 of the first module 2 can be designed both for setting up the radio channel 52 over the galvanic isolation 4 and for configuring the wireless link 9. However, as shown in FIG. 3, a separate antenna can also be provided for setting up the wireless link 9 at the first module 2. It is also possible that a plurality of second modules 3 are wire-connected to one another but have a common antenna in order to set up the wireless link 9 to the first module 2.

In an alternative embodiment of the present invention, the modules 2, 3 communicate by a power line on the secondary side, one example of this being switching information (for example AC/power line) on a DC supply voltage of the modules 2, 3. By this means, a separate communication link can be omitted and only the common supply voltage line, present in any case, is used for transmitting the dimming information within the master-slave subsystem.

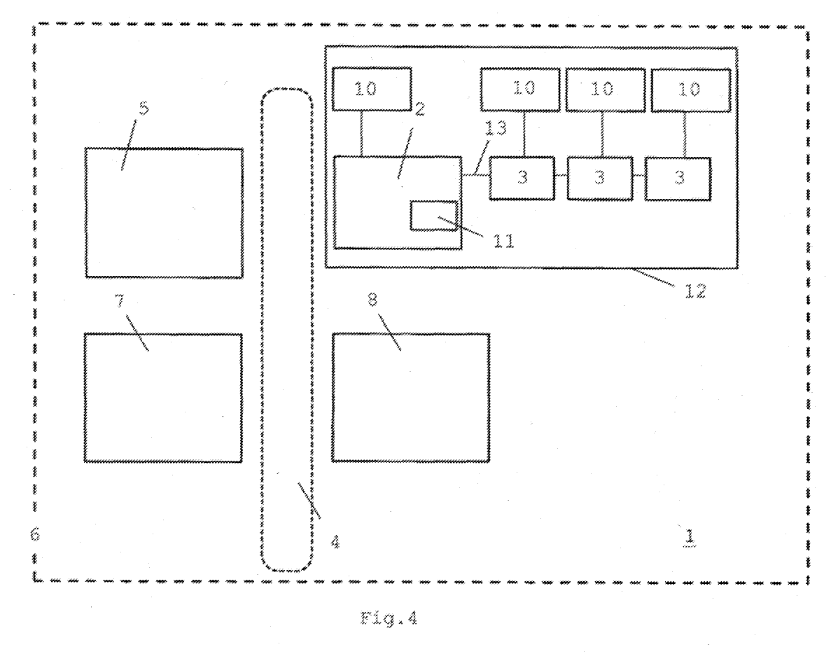

FIG. 4 shows a third embodiment of the present invention. The third embodiment is even more efficient with regard to costs than the embodiments described above. In particular, the lamps 10 and the modules 2, 3 are integrated on a lamp module 12, preferably an LED module. The modules 2, 3 can be constructed on the circuit board or the PCB or a semiconductor material of the lamp module 12. The first module 2 is in this case constructed as a sensor module, that is to say it comprises at least one sensor 11. The at least one sensor 11 can be a daylight sensor, a presence sensor or an infrared sensor. The sensor 11 is configured to receive sensor information. The sensor information is, for example, information with respect to the current daylight, information about persons or vehicles in the vicinity of the sensor, or an infrared signal, for example from a remote control.

In this embodiment of the invention, the first module 2 is configured to readout the detected sensor information of the sensor 11 and determine from this dimming information. The determination can be performed independently or with the aid of the intelligent circuit 8 which can be an ASIC, microcontroller or an integrated circuit. To obtain the dimming information, the first module 2 does not have to communicate via the galvanic isolation 4 in this embodiment of the invention but obtains the dimming information by means of external signals.

In this embodiment, in which the modules 2, 3 are integrated in the lamp module 12, the communication can be carried out via connecting lines and/or thermal management lines or resistance readout lines on the circuit board of the lamp module 12. On the circuit board, a plurality of modules 2, 3 can be wired serially or in parallel which requires only minimum wiring and installation expenditure. The plurality of modules 2, 3 can also be formed as master-slave solution. For example, the one or the plurality of second modules 3 can be designed in such a manner that they are dimmed automatically to the same dimming value which is supplied to the first module 2 via the sensor information 11. The solution of the third embodiment of the invention is especially cost effective and space-saving.

Overall, the present invention has the result that the secondary side of an operating unit 1 is supplied with dimming information with regard to a galvanic isolation 4, the operating unit 1 being improved with respect to costs. In particular, the dimming information is supplied only to a first module 2 (a master module), either from outside or via the galvanic isolation 4, by means of a wireless channel 52. The first module 2 is also configured to forward the dimming information or other operating parameters such as a nominal voltage or a nominal current for operating lamps 10 to at least one second module 3 (at least one slave module). This can be effected either by a local bus 6, a wireless link 9, a supply line or via lines on a lamp module 12. The present invention reduces the plurality of needed communication links over the galvanic isolation 4. Furthermore, no optocouplers or transformers are needed. The operating unit 1 according to the exemplary embodiments of the present invention can, therefore, be constructed more cost effectively than an operating unit 1 from the prior art.

1. An operating unit (1) for at least one lamp (10), the operating unit (1) comprising:
a circuit (5) on a primary side and a circuit (2, 3) on a secondary side which are isolated from one another by galvanic isolation (4);
wherein the at least one lamp (10) can be supplied on the secondary side with respect to the galvanic isolation (4) and the primary side is configured for connection to a voltage supply;
wherein the circuit (2, 3) on the secondary side comprises a first module (2) and at least one second module (3) for dimming a respective lamp (10) allocated thereto;
wherein the circuit (5) on the primary side and the first module (2) have interfaces (50, 20) for configuring a unidirectional or bidirectional wireless channel (52);
wherein the first module (2) is configured to receive dimming information via the wireless channel (52) and to forward the received dimming information to the at least one second module (3).

2. The operating unit (1) as claimed in claim 1, wherein a local bus (6) is arranged between the first module (2) and the at least one second module (3) for the first module (2) to communicate with the at least one second module (3).

3. The operating unit (1) as claimed in claim 2, wherein the first module (2) is configured to apply the dimming information to the bus (6).

4. The operating unit (1) as claimed in claim 1, wherein a wireless link (9) is set up between the first module (2) and the at least one second module (3) for the first module (2) to communicate with the at least one second module (3).

5. The operating unit (1) as claimed in claim 4, wherein the bus (6) or the wireless link (9), respectively, is designed for unidirectional communication from the first module (2) to the at least one second module (3).

6. The operating unit (1) as claimed in claim 4, wherein the bus (6) or the wireless link (9), respectively, is configured for bidirectional communication between the first module (2) and the at least one second module (3).

7. The operating unit (1) as claimed in claim 6, wherein the first module (2) and the at least one second module (3) are configured to exchange the dimming information and/or at least one operating parameter.

8. The operating unit (1) as claimed in claim 1, wherein the first module (2) and the at least one second module (3) are configured to communicate by a power line.

9. The operating unit (1) as claimed in claim 8, wherein the power line communication takes place via switching information on a supply voltage of the first module (2) and of the at least one second module (3).

10. The operating unit (1) as claimed in claim 1, wherein the first module (2) and the at least one second module (3) are converter stages.

11. The operating unit (1) as claimed in claim 1, wherein the wireless channel (52) is a radio channel which is set up by radio interfaces (20, 50).

12. The operating unit (1) as claimed in claim 11, wherein the radio channel (52) is located within a metallic housing (6) of the operating unit (1).

13. An operating unit (1) for at least one lamp (10), the operating unit (1) comprising:
a circuit (5) on a primary side and a circuit (2, 3) on a secondary side which are isolated from one another by galvanic isolation (4);
wherein the at least one lamp (10) can be supplied on the secondary side with respect to the galvanic isolation (4) and the primary side is configured for connection to a voltage supply;
wherein the circuit (2, 3) on the secondary side comprises a first module (2) and at least one second module (3) for dimming a respective lamp (10) allocated thereto;
wherein the first module (2) comprises at least one sensor (11) and is configured to determine dimming information on the basis of detected sensor information and to forward the dimming information determined to the at least one second module (3).

14. The operating unit (1) as claimed in claim 13, wherein the at least one sensor (11) is a daylight sensor, a presence sensor or infrared sensor.

15. The operating unit (1) as claimed in claim 13, wherein the first module (2) and the at least one second module (3) are integrated in a lamp module (12), which comprises the at least one lamp (10).

16. The operating unit (1) as claimed in claim 15, wherein the first module (2) and the at least one second module (3) are configured to communicate via at least one thermal management or resistance readout line (13) of the lamp module (12).

17. An LED lamp having an LED line which is supplied, starting from a secondary side of an operating unit (1) as a claimed in claim 1.

18. A method for operating (1) lamps (10), the method comprising:
providing an electrical supply for the lamps (10) by means of a circuit (5) on a primary side and a circuit (2, 3) on a secondary side which are isolated from one another by galvanic isolation (4);
adjusting a dimming stage of the lamps (10) in accordance with dimming information;
wherein the circuit (2, 3) on the secondary side comprises a first module (2) and at least one second module (3) for dimming a respective lamp (10) allocated thereto; and
wherein the circuit (5) on the primary side receives dimming information via a unidirectional or bidirectional wireless channel (5) and forwards it to the at least one second module (3).

19. A method for operating (1) lamps (10), the method comprising:
providing an electrical supply for the lamps (10) by means of a circuit (5) on a primary side and a circuit (2, 3) on a secondary side which are isolated from one another by galvanic isolation (4);
adjusting a dimming stage of the lamps (10) in accordance with dimming information;
wherein the circuit (2, 3) on the secondary side comprises a first module (2) and at least one second module (3) for dimming a lamp (10) allocated in each case; and
wherein the first module (2) comprises at least one sensor (11) and determines dimming information on the basis of detected sensor information and forwards the dimming information determined to the at least one second module (3).
